(19) United States
(12) Patent Application Publication
(10) Pub. No.: US 2004/0239790 A1
(43) Pub. Date: Dec. 2, 2004

(54) Image capturing apparatus

(75) Inventors: Toshihisa Maeda, Sakai-Shi (JP); Ryuichi Kitaoka, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/658,728

(22) Filed: Sep. 9, 2003

(30) Foreign Application Priority Data
May 30, 2003 (JP) P2003-154993

(51) Int. Cl. H04N 5/217; H04N 5/202; H04N 3/14; H04N 5/335

(52) U.S. Cl. 348/311; 348/254; 348/223.1; 348/241

(57) ABSTRACT

The present invention provides an image capturing apparatus capable of realizing both improved operability and higher picture quality. In the case where a sports mode which is mainly selected when the subject is a moving subject is set, at the time of image capturing, by electrically connecting a first terminal and a second terminal of a switch to each other to set a state where a base current of a transistor does not flow, a substrate voltage is not switched. On the other hand, in the case where the normal image capturing mode is set which is mainly selected when the subject is stationary, the first terminal and a third terminal of the switch are electrically connected to each other, and a signal is supplied to the base side of the transistor through a resistor, thereby setting so that an emitter current of the transistor flows and switching the substrate voltage.

This application is based on application No. 2003-154993 filed in Japan, the contents of which are hereby incorporated by reference.

### BACKGROUND OF THE INVENTION

1. Field of the Invention

The present invention relates to a technique of driving a solid-state image capturing device.

2. Description of the Background Art

In recent years, in a digital camera, the number of pixels of a solid-state image capturing device such as an interline CCD is being increased for higher picture quality of a captured image, and there is a tendency that a photoelectric converting part in each pixel is formed finer. As the photoelectric converting part is becoming finer, the sensitivity decreases in association with decrease in a photosensitive area in each pixel, and a charge accumulation capacity of each pixel, that is, a handled charge amount also decreases. When the handled charge amount of each pixel decreases, the tone reproduction range (dynamic range) of a camera is narrowed, and it becomes difficult to photograph and reproduce a subject in which the contrast of light and shade is conspicuous.

In order to deal with such a problem, a method of increasing a handled charge amount of the photoelectric converting part by decreasing a substrate voltage of an image capturing device is generally employed. However, when the substrate voltage is lowered, simultaneously, an overflow barrier potential for preventing blooming (phenomenon that charges overflow from a capacitor of the photoelectric converting part to a vertical transfer CCD before start of a charge reading operation and it causes noise of a band shape in a captured image) is also decreased. It causes a situation that blooming easily occurs.

In an actual image capturing device driving circuit, consequently, in a high-speed reading mode for live view (mode of reading while skipping some pixels), blooming is prevented without decreasing the substrate voltage. On the other hand, in an all-pixel reading mode for image capturing, on precondition that charges overflowed to a vertical transfer CCD are discharged just before start of the charge reading operation in order to prevent blooming, a substrate voltage changing circuit for decreasing the substrate voltage to increase the handled charge amount as much as possible is provided in many cases (e.g., U.S. Pat. No. 5,528,291).

However, due to a response characteristic or the like of a transistor used for the substrate voltage changing circuit, it takes considerable time to complete a substrate voltage change since its start. Because of the time, time since the shutter button is depressed until image capturing is started, so-called a release time lag increases. Particularly, in the case of photographing a moving subject, the user misses an opportunity to take a good picture.

In order to deal with such a problem, a method of shortening the response time of the transistor by reducing resistance of a circuit connected to an emitter electrode of the transistor used for the substrate voltage changing circuit is considered. When such a circuit is used, however, a large amount of current flows in the image capturing device driving circuit. Particularly, in exposure for a long time, a dark current due to thermal noise by heat generation occurs, and a problem that the picture quality of a captured image locally deteriorates arises.

### SUMMARY OF THE INVENTION

The present invention is directed to an image capturing apparatus.

According to the present invention, this image capturing apparatus includes: an image sensor in which a charge accumulating device is electrically interposed between a substrate and a charge transfer path; a switching element for switching a substrate voltage in order to control a barrier voltage which is generated between the substrate and the charge accumulating device; and a controller for controlling the switching element so as to selectively inhibit the switching of the substrate voltage at the time of image capturing in accordance with an image capturing condition.

In the image capturing condition requiring high response to an image capturing operation, the operability is improved without switching the substrate voltage. In the image capturing condition requiring high picture quality, by switching the substrate voltage, high picture quality can be achieved. In such a manner, both operability and higher picture quality are satisfied.

In a preferred aspect of the present invention, the image capturing condition includes a present status of an image capturing mode of the image capturing apparatus.

Since the switching of the substrate voltage at the time of image capturing is selectively inhibited on the basis of the present status of the image capturing mode, information indicating whether switching of the substrate voltage is to be inhibited or not can be easily obtained.

In another preferred aspect of the present invention, the image capturing apparatus further includes an image processor for processing image data generated by the image sensor, wherein the image processor changes a process in accordance with a present status of the substrate voltage.

By compensating insufficiency of a dynamic range which occurs when the substrate voltage is high, the picture quality of a captured image can be maintained.

According to another aspect of the present invention, this image capturing apparatus includes: an image sensor in which a charge accumulating device is electrically interposed between a substrate and a charge transfer path; a switching element capable of switching a substrate voltage to control a barrier voltage which is generated between the substrate and the charge accumulating device, wherein switching time required for an operation of switching the substrate voltage is variable; and a controller for changing the switching time for image capturing in accordance with an image capturing condition.

In the image capturing condition requiring high response to an image capturing operation, by shortening the switching response time, the operability is improved. In the image capturing condition in which the degree of request of high response is relatively low, by making switching response time long, high picture quality can be achieved. In such a manner, both operability and higher picture quality are satisfied.

According to another preferred aspect of the present invention, the image capturing condition includes exposure time of the image sensor.

Since the switching response time of the substrate voltage of the image capturing device at the image capturing is changed on the basis of the exposure time, both picture quality of a captured image and a release time lag can be optimized.

The present invention is also directed to a method of switching a substrate voltage in an image capturing apparatus including an image sensor in which a charge accumulating device is electrically interposed between a substrate and a charge transfer path and of which barrier voltage which is generated between the substrate and the charge accumulating device is controllable by switching the substrate voltage.

Therefore, an object of the present invention is to provide an image capturing apparatus capable of preventing the user from missing an opportunity to take a good picture and capable of assuring picture quality of a captured image, that is, an image capturing apparatus capable of realizing both improved operability and higher picture quality.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A to 1C are schematic diagrams showing the appearance of an image capturing apparatus according to a first embodiment;

FIG. 2 is a block diagram showing a functional configuration of the image capturing apparatus;

FIG. 3 is a diagram describing the configuration of a CCD;

FIG. 4 is a diagram showing the structure of a portion around a photoelectric converting part;

FIG. 5 is a diagram showing a potential state of a portion around the photoelectric converting part;

FIG. 6 is a diagram showing a potential state of a portion around the photoelectric converting part;

FIG. 7 is a diagram showing a potential state of a portion around the photoelectric converting part;

FIG. 8 is a diagram showing a potential state of a portion around the photoelectric converting part;

FIG. 9 is a schematic diagram showing a conventional V_{SUB} switching circuit;

FIG. 10 is a schematic diagram showing a V_{SUB} switching circuit according to a first embodiment;

FIG. 11 is a diagram showing parameters of γ correction in a normal image capturing mode;

FIG. 12 is a diagram for describing a loss of a color balance;

FIG. 13 is a diagram showing parameters of γ correction in a sports mode;

FIG. 14 is a diagram for describing correction of a loss of a color balance;

FIG. 15 is a flowchart showing an image capturing operation flow of the image capturing apparatus;

FIG. 16 is a flowchart showing the image capturing operation flow of the image capturing apparatus;

FIG. 17 is a schematic diagram showing a V_{SUB} switching circuit according to a second embodiment;

FIG. 18 is a timing chart showing the relationship between a resistance value r₅ and a change in the substrate voltage V_{SUB};

FIG. 19 is a flowchart showing an image capturing operation of an image capturing apparatus according to the second embodiment; and

FIG. 20 is a flowchart showing the image capturing operation flow of an image capturing apparatus according to a modification.

### DESCRIPTION OF THE PREFERRED EMBODIMENTS

Hereinafter, description will be given of embodiments of the present invention with reference to the drawings.

### 1. First Embodiment

Configuration of Main Components of Image Capturing Apparatus

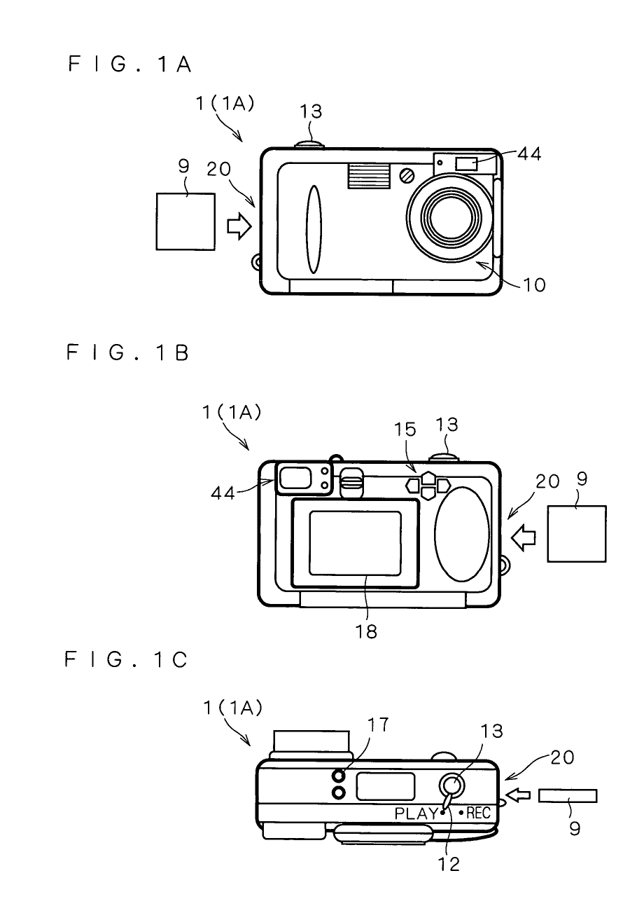

FIGS. 1A, 1B and 1C are front view, rear view and top view, respectively, each schematically showing the appearance of an image capturing apparatus 1 according to a first embodiment of the present invention.

The image capturing apparatus 1 takes the form of a digital camera. On the front face of the image capturing apparatus 1, a taking lens 10 and a viewfinder window 44 are provided. The taking lens 10 includes a lens system which can be driven along the optical axis direction. By driving the lens system in the optical axis direction, a focus state of an image of the subject formed on a CCD (which will be described later) provided in the image capturing apparatus 1 can be achieved.

On the top face of the image capturing apparatus 1, a mode changeover switch 12, a shutter start button (hereinafter, simply referred to as “shutter button”) 13, and a sports mode button 17 are disposed.

The mode changeover switch 12 is a switch for selectively switching a mode such as an image capturing mode and a reproduction mode.

The shutter button 13 is a button depressed by the user at the time of photographing a subject, thereby giving an image capturing instruction to the image capturing apparatus 1. The shutter button 13 can be set in two depressed states of a lightly pressed state (hereinafter, referred to as “S1 state”) and a fully depressed state (hereinafter, referred to as “S2 state”). In an image capturing standby state, the shutter button 13 is depressed to set the S1 state, thereby executing automatic exposure (AE) control and auto-focus (AF) control which will be described later. Further, when the S2 state is set, an image capturing operation which will be described later is executed.

Each time the sports mode button 17 is depressed, a mode can be sequentially switched between a mode for photographing mainly a stationary subject (hereinafter, referred to as “normal image capturing mode”) and a mode of photographing mainly a moving subject (hereinafter, referred to as a “sports mode”).

In the normal image capturing mode, when the shutter button 13 is depressed to set the S1 state, an AF control (so-called one-shot AF control) for stopping the driving of the taking lens 10 when a focus state on the subject is achieved is performed. On the other hand, in the sport mode, after the shutter button 13 is depressed to set the S1 state, an AF control (so-called continuous AF control) for continuously maintaining a focus state on a subject is performed and a shutter speed to the relatively high side is set.

In the image capturing apparatus 1, on the basis of a setting state of the normal image capturing mode or the sports mode, a control of driving a CCD which will be described later and an image process such as T correction are changed. Changes in the drive control of the CCD and the y correction will be described in detail later.

In a side face of the image capturing apparatus 1, a slot 20 into which a memory card 9 for storing image data captured by an image capturing operation (captured image) performed in association with depression of the shutter button 13 by the user can be inserted is formed.

On the rear face of the image capturing apparatus 1, a liquid crystal display (LCD) 18 for displaying a live view of a subject in a moving mode before image capturing, a captured image and the like, an operation button 15 for changing various setting states of the image capturing apparatus 1 such as shutter speed, and the viewfinder window 44 are provided.

Functional Configuration of Image Capturing Apparatus

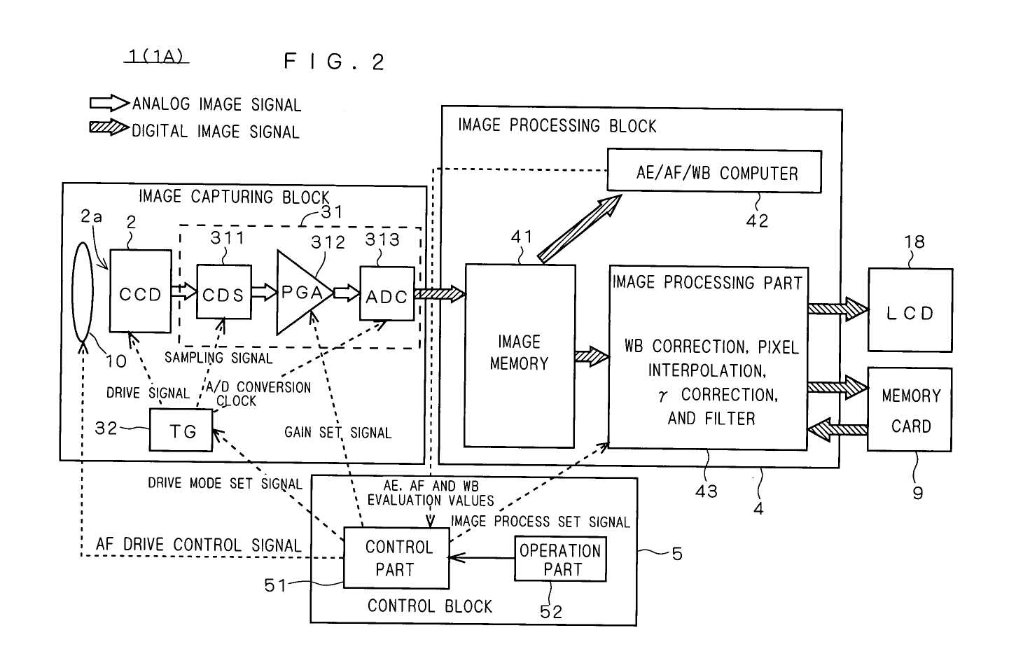

FIG. 2 is a block diagram showing the functional configuration of the image capturing apparatus 1.

The image capturing apparatus 1 has an AFE (Analog Front End) 31 connected to a CCD 2 so that data can be transferred, an image processing block 4 connected to the AFE 31 so that data can be transferred, and a control block 5 for controlling those components in a centralized manner.

On the face facing the taking lens 10 of the CCD 2, a light reception part 2a is provided. In the light reception part 2a, a plurality of (e.g., 2560×1920) pixels are arranged. When light is incident on the light reception part 2a via the taking lens 10, the light is photoelectrically converted by the light reception part 2a and an image signal (video signal) is outputted synchronously with a read signal and a CCD drive signal sent from a timing generator (TG) 32. In the light reception part 2a, a color filter array corresponding to the pixel array is provided. In the color filter array, color filters of three different primary colors such as red (R), green (Gr, Gb) and blue (B) periodically distributed are disposed in a Bayer method. The configuration of the CCD 2 will be further described later.

The CCD 2 has a mode of reading image signals from the whole pixel array (hereinafter, referred to as “all pixel reading mode”) at the time of capturing an image and a mode of reading image signals from pixels obtained by skipping the whole pixel array to ⅛ in the vertical direction (hereinafter, referred to as “monitoring mode”) at the time of live view displaying in the image capturing standby state.

The AFE 31 is constructed as an LSI (Large Scale Integrated Circuit) having a CDS (Correlated Double Sampling device) 311, a PGA (Programmable-Gain-Amplifier) 312 functioning as an amplifier, and an ADC (A/D converter) 313. An image signal outputted from the CCD 2 is sampled by the CDS 311 on the basis of a sampling signal from the TG 32 and is subjected to desired amplification in the PGA 312. The PGA 312 can change the amplification factor by using numerical data obtained via serial communication from a control block 5. An analog signal amplified by the PGA 312 is converted to a digital signal of 12 bits by the ADC 313 and the digital signal is sent to the image processing block 4.

The image processing block 4 has an image memory 41, an AE/AF/WB computer 42 connected to the image memory 41 so that data can be transferred, and an image processing part 43.

The image memory 41 is, e.g., a semiconductor memory and is a part for temporarily storing image data which is converted to a digital signal by the ADC 313. All of image data of one frame is stored in the image memory 41 and, after that, sent to the image processing part 43. The image data is stored in the image memory 41 and, immediately after that, also sent to the AE/AF/WB computer 42.

The AE/AF/WB computer 42 calculates an AE evaluation value, an AF evaluation value and a white balance (WB) evaluation value on the basis of image data sent from the image memory 41.

In the case where the shutter button 13 enters the lightly pressed state (S1 state), the AE/AF/WB computer 42 calculates an average value of all of pixel values of G color of image data sent from the image memory 41 as a luminance value of the subject, i.e., an AE evaluation value. The AE/AE/WB computer 42 calculates an evaluation value (AF evaluation value) as a sum of the absolute value of the difference of pixel values regarding neighboring pixels with respect to data corresponding to a predetermined area out of image data of one frame stored in the image memory 41. Further, the AE/AF/WB computer 42 calculates a WB evaluation value by integrating pixel values (luminance values) for each of R, G and B colors with respect to the image data sent from the image memory 41.

The AE, AF and WB evaluation values calculated by the AE/AF/WB computer 42 are sent to the control block 5.

The image processing part 43 performs an interpolating process based on the color filter characteristics of the CCD 2 on monochromatic image data (monochromatic information constructed only by luminance) sent from the image memory 41, thereby converting the monochromatic image data into color image data. The image processing part 43 performs various image processes such as automatic white balance (AWB) correction for obtaining desired color balance, γ correction for obtaining natural tone, and a filter process for performing contour emphasis and saturation adjustment. Herein, the AWB correction is made, γ correction and the like is made and, subsequently, color processing (so-called pixel interpolation) is performed.

An image processed by the image processing part 43 is displayed on the LCD 18 or stored in the memory card 9. Further, the image stored in the memory card 9 can be reproduced and displayed on the LCD 18.

The control block 5 has a control part 51 and an operation part 52 connected to the control part 51 so that data can be transferred.

The operation part 52 is constructed by various operation members such as the mode changeover switch 12, shutter button 13, sports mode button 17, and operation button 15. When the user operates the operation part 52, various modes and the like can be set. Various mode setting states are controlled and managed by the control part 51.

The control part 51 is a part having a CPU and a memory and controlling the components of the image capturing apparatus 1 in a centralized manner. For example, on the basis of the AE, AF and WB evaluation values sent from the AE/AF/WB computer 42, the control part 51 transmits, as optimized set values, a signal of a gain setting in the PGA 312 as a processing part in the pre-stage, a signal of image process setting in the image processing part 43 as a processing part in the post-stage, and an AF drive control signal of a lens unit in the taking lens 10.

The control part 51 performs gain setting on the PGA 312 and adjustment of exposure time (shutter speed) and an aperture at the time of image capturing or live view display (monitoring of a subject). Further, the control part 51 drives and controls the CCD 2 via the TG 32 and realizes switching of a substrate voltage in the CCD 2 which will be described later.

Switching of Substrate Voltage in CCD

Configuration of CCD

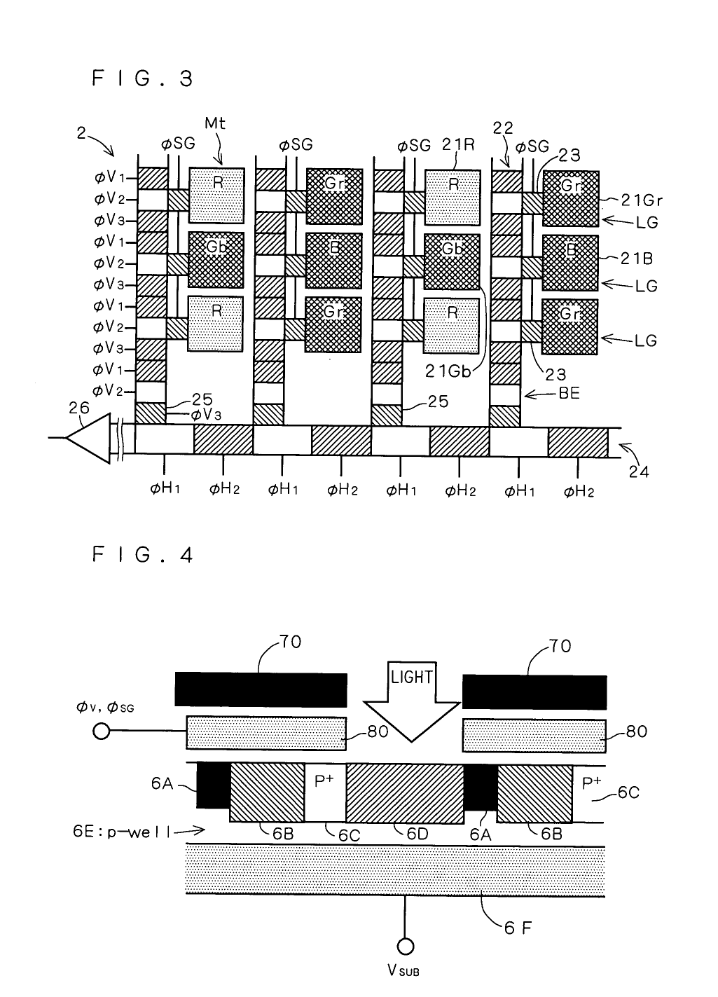

FIG. 3 is a diagram showing the configuration of the CCD 2.

The CCD 2 is constructed as a solid-state image capturing device of an interline transfer type all-pixel reading type (progressive type). The CCD 2 has: a pixel matrix Mt in which photoelectric converting parts (pixels) 21 (21R, 21Gr, 21Gb, 21B) for receiving reflection light (incident light) from a subject and performing photoelectric conversion are arranged; a read gate 23 for transferring each of signal charges accumulated in the pixel matrix Mt to a vertical transfer CCD 22; a horizontal CCD transfer gate 25 for transferring the signal charge vertically transferred by the vertical transfer CCD 22 to a horizontal transfer CCD 24; and an output amplifier 26 for outputting the signal charge transferred to the horizontal transfer CCD 24.

The photoelectric converting part 21 is divided into pixels 21R having a color filter of red (R) color, pixels 21Gr and 21Gb having a color filter of green (G) color, and a pixel 21B having a color filter of blue (B) color. The pixels 21 are arranged in the vertical and horizontal directions in the pixel matrix Mt.

The horizontal CCD transfer gate 25 selectively transfers a plurality of signal charges related to each pixel line LG in the horizontal direction transferred from the pixel matrix Mt to the vertical transfer CCD 22 to the horizontal transfer CCD 24.

Structure in Portion Around Photoelectric Converting Part in CCD

FIG. 4 is a diagram showing the structure in a portion around the photoelectric converting part 21 of the CCD 2.

As shown in FIG. 4, a p-type semiconductor (P-well) 6E is formed on an n-type semiconductor substrate (n-substrate) 6F and a photo diode part 6D taking the form of a pn junction diode is formed on the p-type semiconductor 6E. When reflection light (incident light) from the subject is incident on the photo diode part 6D, the light is photoelectrically converted by the photo diode part 6D and a signal charge is accumulated. In order to prevent incident light from entering the portion other than the photo diode part 6D and from performing unnecessary photoelectric conversion, an aluminum (Al) shielding film 70 is formed so as to cover the portion other than the photo diode part 6D of the light reception part 2a of the CCD 2. Further, between the photo diode part 6D and a vertical transfer CCD 6B for a pixel adjacent to the photo diode part 6D, a channel stop 6A of which potential is maintained low by increasing the amount of impurity is formed in such a manner that the signal charge does not leak. In other words, a charge accumulation device (herein, the photo diode part 6D) is electrically inserted between the n-substrate 6F and the charge transfer path (herein, the vertical transfer CCD 6B).

When a field shift pulse voltage (φ_{SG}) is applied to a transfer electrode (P—Si electrode) 80, the potential of a channel part 6C made of p⁺ semiconductor disposed between the photo diode part 6D and the vertical transfer CCD 6B fluctuates and signal charges accumulated in the photo diode part 6D move to the vertical transfer CCD 6B. After that, by applying a drive pulse potential (φ_{V}) to the P—Si electrode 80, a vertical transfer operation of the signal charges in the vertical transfer CCD 6B is performed and the signal charges are sequentially outputted.

Potential State of Photoelectric Converting Part

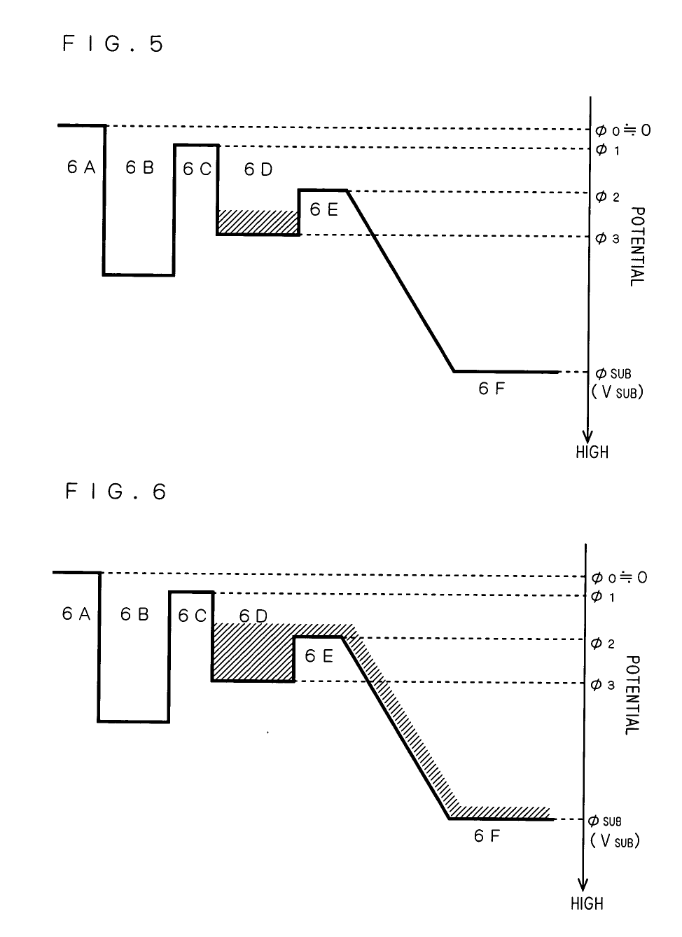

FIGS. 5 to 8 are diagrams each showing the state of potential in a portion around the photoelectric converting part. Parts 6A to 6F in FIGS. 5 to 8 show the potential states of the channel stop 6A, vertical transfer CCD 6B, channel part 6C, photo diode part 6D, P-well 6E and n-substrate 6F shown in FIG. 4, respectively.

In FIGS. 5 to 8, the potential of the channel stop 6A is shown as φ₀, the potential of the channel part 6C is expressed as φ₁, the potential of the photo diode part 6D is expressed as φ₃, the potential of the P-well 6E is expressed as φ₂, and the potential of the n-substrate 6F is expressed as φ_{SUB}. Herein, φ₀ is designed so as to be almost 0 (ground level) and each of potentials φ₁ to φ₃ and φ_{SUB} indicates a value of which reference is the ground (GND) level. In the following, the potential difference between the ground level and the potential φ_{SUB} of the n-substrate 6F will be also referred to as the substrate voltage V_{SUB}.

When the electrostatic capacity of the pn junction diode of the photo diode part 6D is expressed as C, at the time of photoelectric conversion, the maximum charge amount Qₘₐₓ accumulated in the photo diode part 6D is expressed as Qₘₐₓ=C(φ₃−φ₂). In the case where an amount of incident light is excessive, the amount of signal charges generated by the photoelectric conversion exceeds the amount of charges which can be held by the photo diode part 6D and the signal charges overflows to the peripheral portion. When the overflowed signal charges flow into the vertical transfer CCD 6B, blooming occurs.

Therefore, usually, in order to prevent occurrence of blooming, the potentials in the channel part 6C and the p-well 6E are set so as to satisfy the relationship of φ₂>φ₁, and it is designed to perform so-called overflow drain of draining signal charges overflowed from the photo diode part 6D by excessive photoelectric conversion from the n-substrate 6F side (FIG. 6) Because of such a concept, the potential φ₂ of the p-well 6E is called an overflow barrier (OFB) potential.

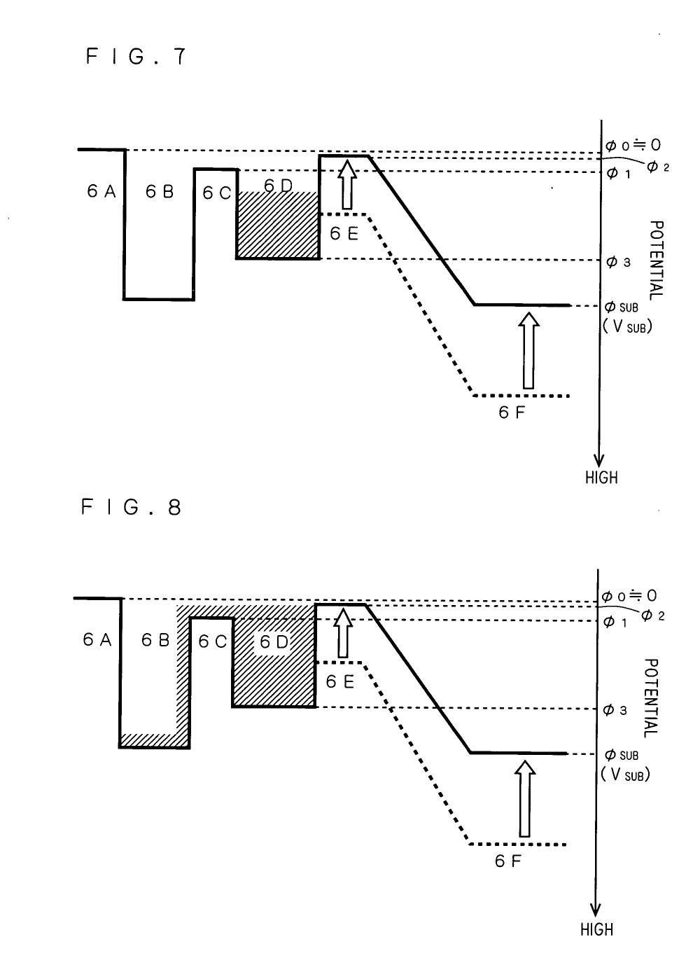

In order to increase the maximum charge amount Qₘₐₓ (i.e., dynamic range) of the photo diode part 6D, it is necessary to set the OFB potential φ₂ as low as possible. Conventionally, a method of decreasing the potential φ_{SUB} (i.e., the substrate voltage V_{SUB}) applied to the n-substrate 6F and lowering the OFB potential φ₂ is used (FIG. 7). However, when the OFB potential φ₂ is lowered and the relationship of φ₂<φ₁ is satisfied, if the amount of signal charges exceeds the maximum capacity of the photo diode part 6D, the signal charges are saturated and overflowed to the vertical transfer CCD 6B (FIG. 8).

Consequently, in order to prevent occurrence of blooming in an image captured by the image capturing operation, at the time of the image capturing, it is necessary to drive the vertical transfer CCD 6B just before the field shift pulse voltage (φ_{SG}) is applied and to preliminarily eliminate unnecessary signal charges overflowed to the vertical transfer CCD 6B.

However, in a reading mode (monitoring mode) requiring a high frame rate (e.g., 1/30 second) for live view display (motion image display) or the like, there is no time to eliminate unnecessary signal charges overflowed in the vertical transfer CCD 6B in advance. Consequently, in the monitoring mode, in order to prevent occurrence of blooming, the substrate voltage V_{SUB} should not be switched.

Generally, switching of the substrate voltage V_{SUB} is limited to the time of capturing a still image in which time for eliminating unnecessary charges in the vertical transfer CCD 6B in advance can be provided.

Substrate Voltage Switching Circuit

Next, description will be given of a circuit for switching the substrate voltage V_{SUB} (hereinafter, referred to as “V_{SUB} switching circuit”). First, description will be given of an example of a conventional V_{SUB} switching circuit 900 and its problem. After that, description will be given of a V_{SUB} switching circuit 100 according to the first embodiment.

Conventional V_{SUB} Switching Circuit

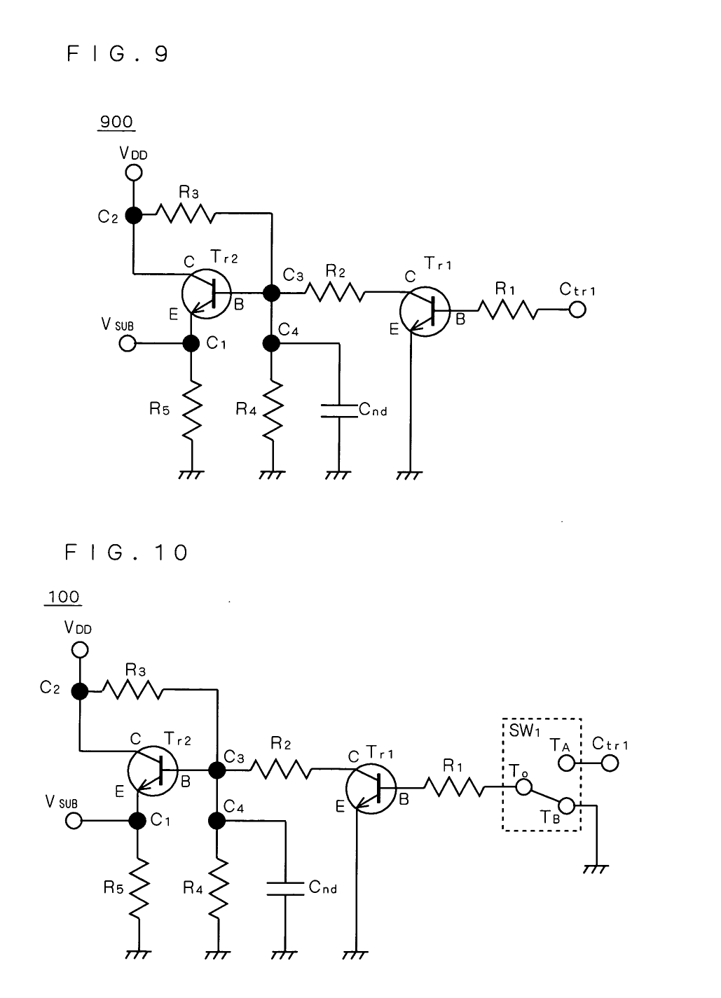

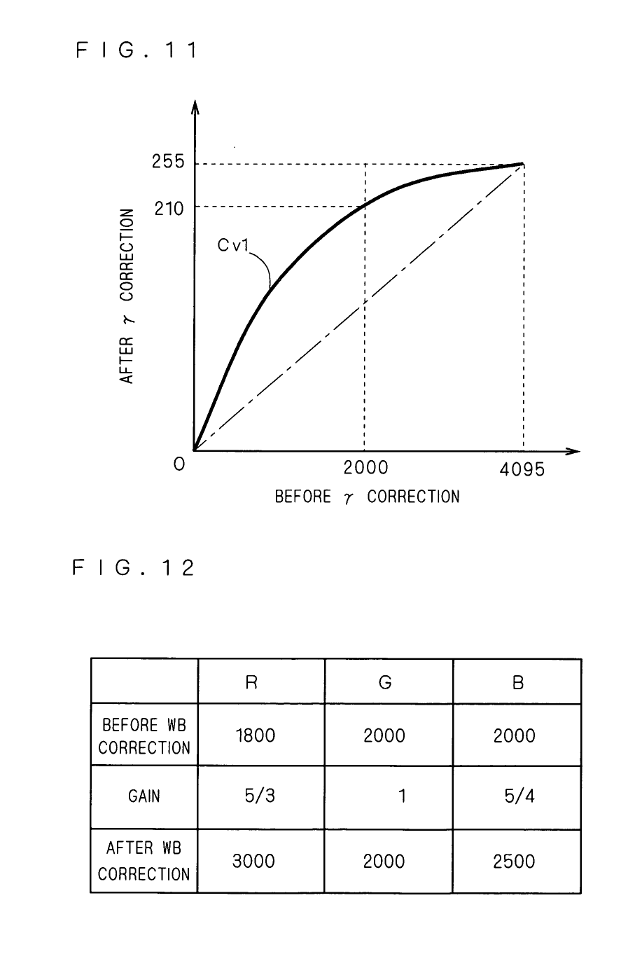

FIG. 9 is a schematic diagram showing the conventional V_{SUB} switching circuit 900. In FIG. 9, only main components of the V_{SUB} switching circuit 900 are shown in a simplified manner.

The V_{SUB} switching circuit 900 is constructed by npn type transistors (hereinafter, simply referred to as “transistors”) Tᵣ₁ and Tᵣ₂, resistors R₁ to R₅, and a capacitor C_{nd}.

The base B of the transistor Tᵣ₁ is electrically connected to the TG 32 via the resistor R₁. Under control of the control block 5, a control signal (Cₜᵣ₁ signal) of the V_{SUB} switching circuit 900 is given from the TG 32 to the base B. The collector C of the transistor Tᵣ₁ is electrically connected to a connection point C₃ via the resistor R₂. The connection point C₃ is electrically connected to a connection point C₄ and is also grounded via the resistor R₄. The connection point C₃ is also grounded via the capacitor C_{nd} in addition to the resistor R₄. The emitter E of the transistor Tᵣ₁ is grounded.

The base B of the transistor Tᵣ₂ is electrically connected to the connection point C₃. The collector C of the transistor Tᵣ₂ is connected to a circuit power source (not shown) which gives a voltage V_{DD} of which reference is the GND level. A connection point C₂ is provided between the collector C of the transistor Tᵣ₂ and the circuit power source. The connection points C₂ and C₃ are electrically connected to each other via the resistor R₃. Between the connection points C₂ and C₃, the resistor R₃ and the transistor Tᵣ₂ are electrically connected in parallel. The emitter E of the transistor Tᵣ₂ is electrically connected to a connection point C₁. The connection point C₁ is grounded via the register R₅ and is electrically connected to the n-substrate 6F of the CCD 2, and the substrate voltage V_{SUB} of which GND level is used as a reference.

A Cₜᵣ₁ signal usually enters an OFF state (state where the signal is not given), i.e., at the GND level. At this time, no base current is passed to the transistor Tᵣ₁, so that the transistor Tᵣ₁ is in the OFF state, i.e., the state where no emitter current flows. In this case, the substrate voltage V_{SUB} is determined by the base voltage of the transistor Tᵣ₂, i.e., a voltage dividing ratio between the resistors R₃ and R₄ of the voltage V_{DD}.

On the other hand, when the Cₜᵣ₁ signal is set to the ON state (state where the Cₜᵣ₁ signal is given), a base current flows in the transistor Tᵣ₁ and the transistor Tᵣ₁ enters the ON state, i.e., an emitter current flows. In this case, the base voltage of the transistor Tᵣ₂ decreases according to change in the voltage dividing ratio due to the resistor R₂ and, as a result, the substrate voltage V_{SUB} can be reduced.

By turning on/off the Cₜᵣ₁ signal to decrease the substrate voltage V_{SUB}, the OFB potential φ₂ is set low and the maximum charge amount Qₘₐₓ of the photo diode part 6D can be increased. In other words, by changing the substrate voltage V_{SUB}, a barrier voltage (herein, OFB potential φ₂) between the n-substrate 6F and the photo diode part 6D can be controlled.

In the following, the state where the substrate voltage V_{SUB} is decreased will be referred to as a “state where the V_{SUB} switching circuit is ON (driven state)” and the state where the substrate voltage V_{SUB} is not decreased will be referred to as a “state where the state where the V_{SUB} switching circuit is OFF (non-driven state)” in some cases.

The time required for change in the substrate voltage V_{SUB} by ON/OFF of the Cₜᵣ₁ signal (hereinafter, referred to as “V_{SUB} switch response time”) depends on response characteristic of the transistor Tᵣ₂ and a resistance value of the resistor R₅ electrically connected to the emitter E side of the transistor Tᵣ₂. At present, in a general CCD image capturing device generally used for a digital camera, the transistor Tᵣ₂ as a main part and the like in the V_{SUB} switching circuit 900 is disposed in the CCD image capturing device, so that it is not easily replaced/changed. In the case of using a general CCD image capturing device, therefore, in order to reduce the V_{SUB} switch response time, the resistance value of the resistor R₅ is reduced.

However, when the resistance value of the resistor R₅ is reduced, current passing through the transistor Tᵣ₂ increases at the time of switching the substrate voltage V_{SUB}, and an amount of heat generation in a portion from the transistor Tᵣ₂ to the resistor R₅ increases. Particularly, in a case of, for example, photographing a subject of low luminance requiring exposure for a long time, local heat noise occurs in the photoelectric converting part disposed near the transistor Tᵣ₂, and it might cause dark current and, further, deterioration in picture quality. Consequently, there is a problem that the resistance value of the resistor R₅ cannot be decreased unnecessarily.

V_{SUB} Switching Circuit According to First Embodiment

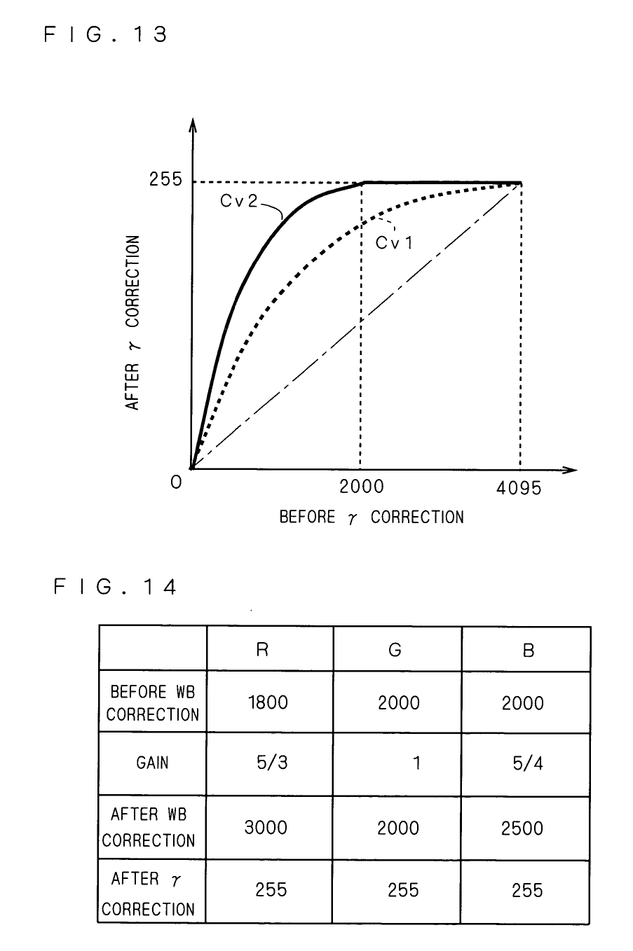

FIG. 10 is a schematic diagram showing the V_{SUB} switching circuit 100 according to the first embodiment. The V_{SUB} switching circuit 100 is obtained by adding a switch SW₁ for masking the Cₜᵣ₁ signal to the V_{SUB} switching circuit 900 shown in FIG. 9. The other part of the V_{SUB} switching circuit 100 is substantially the same as the V_{SUB} switching circuit 900. Similar parts will be designated by similar reference numerals and their description will not be repeated. Only the different part will be described.

As shown in FIG. 10, the switch SW₁ is electrically connected to the base B side of the transistor Tᵣ₁ via the resistor R₁. The switch SW₁ is provided with three terminals T_{O}, T_{A} and T_{B}. The state can be switched between a state where the terminals T_{O} and T_{A} are electrically connected to each other (hereinafter, referred to as “state A”) and a state where the terminals T_{O} and T_{B} are electrically connected to each other (hereinafter, referred to as “state B”). The switch between the states A and B is controlled on the basis of a drive signal from the TG 32 under control of the control part 51.

The resistor R₁ and the terminal T_{O} are electrically connected to each other, the terminal T_{A} is electrically connected to the TG 32 and, under control of the control block 5, the Cₜᵣ₁ signal is given from the TG 32. Further, the terminal T_{B} is grounded and its potential is set to the GND level. That is, in the V_{SUB} switching circuit 100, according to an object of image capturing, whether the operation of switching the substrate voltage V_{SUB} by switching the states A and B in the switch SW₁ is performed or not can be selectively set.

That is, the V_{SUB} switching circuit 100 can be set to the ON or OFF state, in other words, a valid state or invalid state under control of the control part 51. In the switch SW₁, in a normal state, the terminals T_{O} and T_{B} are electrically connected. Under control of the control part 51, at the time of image capturing, the terminals T_{O} and T_{A} are electrically connected to each other according to the object of image capturing, thereby setting the V_{SUB} switching circuit 100 in the ON state (drive state).

For example, in the case of photographing a moving subject, in order to prevent an opportunity to take a good picture from being missed, the switch SW₁ is always set in the state B and the transistor Tᵣ₁ is set to the OFF state (i.e., the V_{SUB} switching circuit 100 is set to the OFF state), thereby preventing occurrence of waiting for V_{SUB} switching response time and suppressing a release time lag. The Cₜᵣ₁ signal is always given to the terminal T_{A} in the image capturing operation and, by the switch SW₁, whether the signal Cₜᵣ₁ is given to the base B of the transistor Tᵣ₁ or not is adjusted.

Herein, the object of image capturing is determined and the switch SW₁ is controlled by the control part 5l. An example of conditions of determining the object of image capturing is a setting state of a sports mode (mode which provides image capturing parameters optimum to photograph a moving subject) which is changed by operation of the operation part 52 by the user. Concretely, in the case where the sports mode is set, the control part 51 switches/sets the switch SW₁ to the state B by a control via the TG 32 and, at the time of image capturing, the transistor Tᵣ₁ is always in the OFF state so that the substrate voltage V_{SUB} is not switched.

In short, the image capturing apparatus 1 has the V_{SUB} switching circuit 100 capable of switching the substrate voltage V_{SUB} of the CCD 2, and the V_{SUB} switching circuit 100 switches the substrate voltage V_{SUB}. The switch SW₁ sets/controls whether the substrate voltage V_{SUB} is switched or not in the image capturing in accordance with the image capturing conditions such as a setting state of the image capturing mode (herein, sports mode). In order words, the switch SW₁ is provided so as to be able to control the V_{SUB} switching circuit 100 and selectively inhibits switching of the substrate voltage V_{SUB} in the image capturing operation in accordance with the image capturing conditions.

In other words, under control of the control part 51, the switch SW₁ switches/sets the state between the state where the substrate voltage V_{SUB} can be switched and the state where the substrate voltage V_{SUB} cannot be switched, according to the image capturing conditions such as a setting state of the image capturing mode. That is, under control of the control unit 51, according to the image capturing conditions such as a setting state of the image capturing mode, the switch SW₁ switches so as to decrease the substrate voltage V_{SUB} at the time of image capturing.

Change in Image Processing

As described above, when photographing is performed without switching the substrate voltage V_{SUB}, the maximum charge amount Qₘₐₓ accumulated in the photo diode part 6D does not increase. Consequently, the amount of charges dealt by the photoelectric converting part decreases and, as a result, the dynamic range is narrowed.

In order to compensate the narrowing of the dynamic range, for example, by making a parameter of γ correction (curve of γ characteristic) hard, the image processing part 43 performs an image process (herein, γ correction) which does not deteriorates the tone characteristics of the captured image as much as possible. That is, in both of the normal image capturing mode and the sports mode, the γ correction parameter is changed. Specifically, by the control of the control part 51, the image processing part 43 changes the image process (herein, γ correction) for a captured image in accordance with whether the substrate voltage V_{SUB} is changed or not. In other words, by the control of the control part 51, the image processing part 43 changes the image process (herein, γ correction) for a captured image in accordance with the switching state of the substrate voltage V_{SUB}.

Further, in other words, when the state where the substrate voltage V_{SUB} can be switched is set, the image processing part 43 changes the γ correction for a captured image. Specifically, in the case where the substrate voltage V_{SUB} is decreased in the image capturing, the image processing part 43 changes the γ correction for a captured image.

FIG. 11 is a diagram showing a curve C_{V1} of the γ characteristic (tone converting characteristic) as a parameter of γ correction in the normal image capturing mode. FIG. 11 shows a curve associating pixel values before and after γ correction. The lateral axis denotes the pixel value (numerical value indicating luminance in tone) of digital image data before γ correction. The vertical axis denotes the pixel value of digital image data after γ correction. The curve C_{V1} shows the relationship of pixel values before and after γ correction. Since image data is converted by the ADC 313 into digital image data of 12 bits, before the γ correction, the maximum pixel value is 4095. By the γ correction, image data is converted to digital image data of 8 bits (having the number of tones of pixel values is 256).

Concretely, tone conversion (γ correction) of enhancing the contrast of luminance from shadow to middle tone and, on the contrary, weakening the contrast of luminance from middle tone to highlight tone is performed.

In the case of performing image capturing without switching the substrate voltage V_{SUB}, the dynamic range is narrowed and, for example, there may be a case such that the pixel value of digital image data before γ correction reaches up to 2000 at the maximum. In such a case, for example, as shown in FIG. 11, the pixel value in the digital image data subjected to γ correction reaches only 210 at the maximum and the tone in the high luminance portion of a captured image cannot be sufficiently expressed.

Further, in the case where the dynamic range is narrowed, if the γ correction parameter in the normal image capturing mode is employed, a phenomenon occurs such that the color balance deteriorates conspicuously by AWB correction in the high luminance portion of a captured image.

Herein, descriptions will be give of a general AWB correction method, loss of color balance caused by the AWB correction in the case where the dynamic range is narrowed, and a method of compensating reduction in the dynamic range and making the color balance proper (change in the γ correction parameter).

General AWB Correcting Method

For example, the AE/AF/WB computer 42 divides an image based on image data inputted from the image memory 41 into 16×12 blocks of the same size. Subsequently, the pixel values of each of R, G and B colors are integrated on the block unit basis, thereby obtaining Rbij, Gbij and Bbij (1≦i≦12, 1≦j≦16). Average values of the Rbij, Gbij and Bbij are computed as WB evaluation values Rs, Gs and Bs, respectively.

In the control part 51, gr=Rs/Gs and gb=Bs/Gs are computed. Further, set values kr and kb of gains of R and B (R gain set value and B gain set value) satisfying the relation of gr×kr=gb×kb=1 are obtained and AWB correction is made in the image processing part 43 every photographing. For example, in the case of Rs:Gs:Bs=3:5:4, gr=3/5 and gb=4/5 are calculated, and the R gain set value kr=5/3 and the B gain set value kb=5/4 are obtained.

Loss of Color Balance Caused by Narrowing of Dynamic Range

Generally, photographing is performed in various compositions. In many cases, a low luminance part (low-luminance subject) and a high luminance part (high-luminance subject such as sky) mixedly exist in an image of one frame. In the following, description will be given of a phenomenon that color balance of a high-luminance portion deteriorates with respect to the case where the R gain set value kr=5/3 and the B gain set value kb=5/4 are computed will be described.

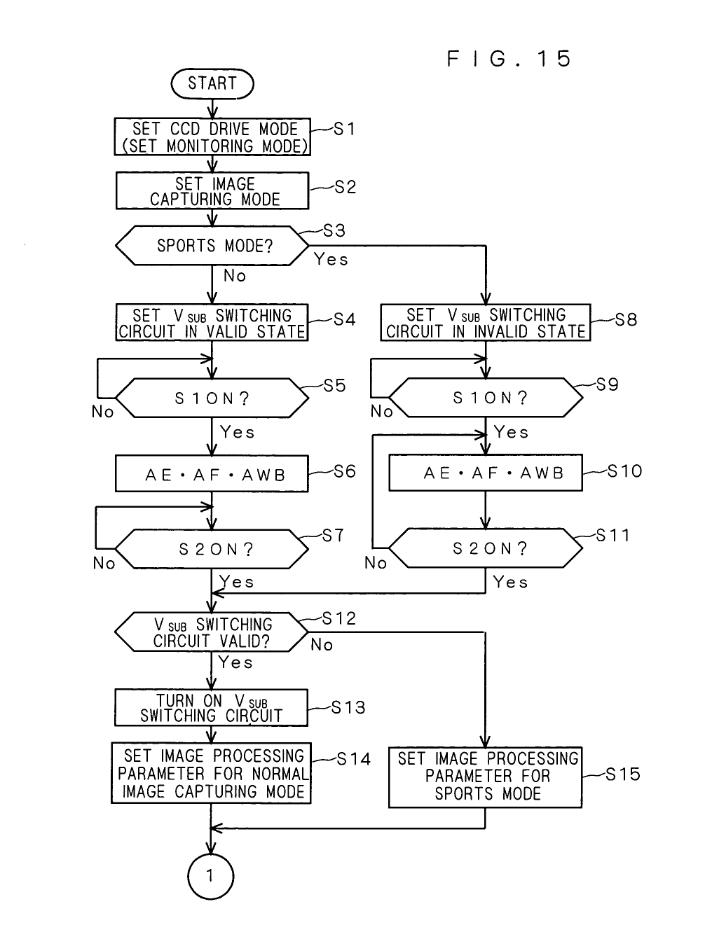

FIG. 12 is a diagram for describing loss of color balance, in which attention is paid to each pixel and pixel values of R, G and B before AWB correction, gain set values, and pixel values of R, G and B after the AWB correction are sequentially shown from above.

For example, before the γ correction, even in the case where the maximum pixel value is 4095 when the substrate voltage V_{SUB} is decreased and image capturing is performed, if image capturing is performed without switching the substrate voltage V_{SUB}, the dynamic range becomes narrow. For example, there may be a case such that the maximum pixel value in image data inputted from the ADC 313 to the image memory 41 is only 2000.

In such a case, as shown in FIG. 12, although the pixel value of G color is supposed to be 2001 or more (e.g., 3000) in a high-luminance portion in image data temporarily stored in the image memory 41, a case such that the pixel value of G color is saturated at 2000 can easily happen. Concretely, for example, it is expected that the pixel values of the high-luminance portion before the AWB correction become like R=1800, G=2000 and B=2000. In such a case, in AWB correction, by the gain set values kr=5/3 and kb=5/4, the pixel values are set as R=3000 (=1800×5/3), G=2000 (=2000×1) and B=2500 (=2000×5/4).

Herein, before the AWB correction, by narrowing the dynamic range in the CCD 2, the maximum pixel value becomes 2000. However, as shown in FIG. 11, the upper limit of the pixel value which can be handled is 4095. Consequently, after the AWB correction, the pixel value of G color remains 2000 as the upper limit of the dynamic range. The pixel values of R and B colors are amplified to values of 2001 or more (herein, R=3000 and B=2500) by the gain set values kr and kb. The pixel values of the high luminance portion should become R=3000, G=3000 and B=2500. Actually, however, by narrowing the dynamic range, the pixel values become R=3000, G=2000 and B=2500.

On the image data subjected to the AWB correction as described above, in the image processing part 43, γ correction according to the curve C_{V1} indicative of the γ characteristic as shown in FIG. 11 is made. For example, by the γ correction, the pixel values of the high luminance portion should become R=240, G=240 and B=225 which express lightly-reddish white. Actually, however, the pixel values become R=240, G=210 and B=225 by the γ correction.

When the gain set values kr and kb obtained from the whole image of one frame are applied to, for example, a high luminance portion in which the pixel value of G color is saturated, the pixel values of R and B colors become too large with respect to the pixel values of G color. As a result, the high luminance portion becomes a portion in which the R and B colors are enhanced more than an actual subject, and the color balance in the high luminance portion is lost.

Change in γ Correction Parameter

When the sports mode is set, as described above, without switching the substrate voltage V_{SUB}, image capturing is performed. Consequently, the dynamic range is narrowed, and there may be a case such that the maximum pixel value in image data inputted from the ADC 313 to the image memory 41 reaches only 2000. In the following, description will be given of the case where the pixel value in image data inputted from the ADC 313 to the image memory 41 reaches only 2000 at the maximum as an example.

FIG. 13 is a diagram showing a curve C_{V2} of a γ characteristic as a γ correction parameter in the sports mode. FIG. 13 shows, in a manner similar to FIG. 11, a curve associating pixel values before and after γ correction. The lateral axis denotes the pixel value (numerical value indicating luminance in tone) of digital image data before γ correction. The vertical axis denotes the pixel value of digital image data after γ correction. The curve C_{V2} shows the relationship of pixel values before and after γ correction. In FIG. 13, for comparison, the curve C_{V1} of the γ characteristic in the normal image capturing mode shown in FIG. 11 is indicated by a dotted line.

As shown in FIG. 13, a tone conversion characteristic (γ correction characteristic) is provided such that the pixel value after γ correction is 255 in the case where the pixel value before γ correction is 2000 or more, and with respect to pixel values from 0 to 2000, the contrast of luminance from shadow to middle tone is enhanced and, on the contrary, the contrast of luminance from middle tone to highlight tone is weakened.

Specifically, a predetermined pixel value (herein, 2000) or more is converted by γ correction to a predetermined pixel value (herein, 255) as the maximum value in a range of corrected pixel values. A pixel value less than the predetermined pixel value in a range of pixel values less than the predetermined pixel value is subjected to tone conversion such that the contrast of luminance from the shadow to middle tone is enhanced and, on the contrary, the contrast of luminance from the middle tone to the highlight tone is weakened.

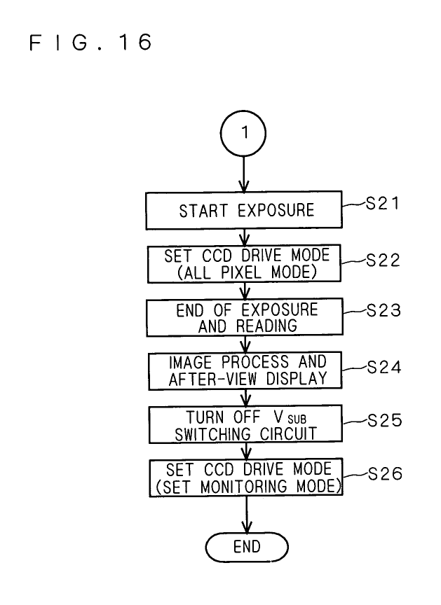

FIG. 14 is a diagram for describing correction of loss of color balance, in which attention is paid to each pixel and pixel values of R, G and B before AWB correction, gain set values, pixel values of R, G and B after the AWB correction, and pixel values of R, G and B after γ correction are sequentially shown from above.

Also in the case where the pixel values after AWB correction are R=3000, G=2000 and B=2500 as shown in FIG. 12, by the γ correction according to the γ characteristic as shown in FIG. 13, the pixel values after γ correction are R=255, G=255 and B=255. Although color balance is lost once by AWB correction with respect to a high luminance portion originally close to white color, the color can be converted by the γ correction to a color close to white color. Consequently, the color balance of image data obtained finally can be corrected to proper balance.

As described above, in the sports mode, the maximum pixel value in image data inputted from the ADC 313 to the image memory 41 is 2000. If γ correction is made according to the γ characteristic in the normal image capturing mode, for example, the pixel value of G color reaches only 210 at the maximum, so that the tone in the high luminance portion of a captured image finally obtained cannot be sufficiently expressed.

However, in the case where the image capturing apparatus 1 according to the embodiment is set in the sports mode, γ correction according to the γ characteristic as shown in FIG. 13 is performed so that the maximum pixel value (herein, 2000) in image data inputted from the ADC 313 to the image memory 41 becomes the maximum pixel value (herein, 255) after correction.

Even in the case where the dynamic range is narrowed, captured image data can be expressed by using all range of pixel values after γ correction. In other words, γ correction having the tone converting characteristic which enhances the contrast of luminance (pixel value) is performed on the pixel value of each of color components of image data. As a result, the tone in the high luminance portion of a captured image finally obtained can be sufficiently expressed.

Image Capturing Operation Flow of Image Capturing Apparatus

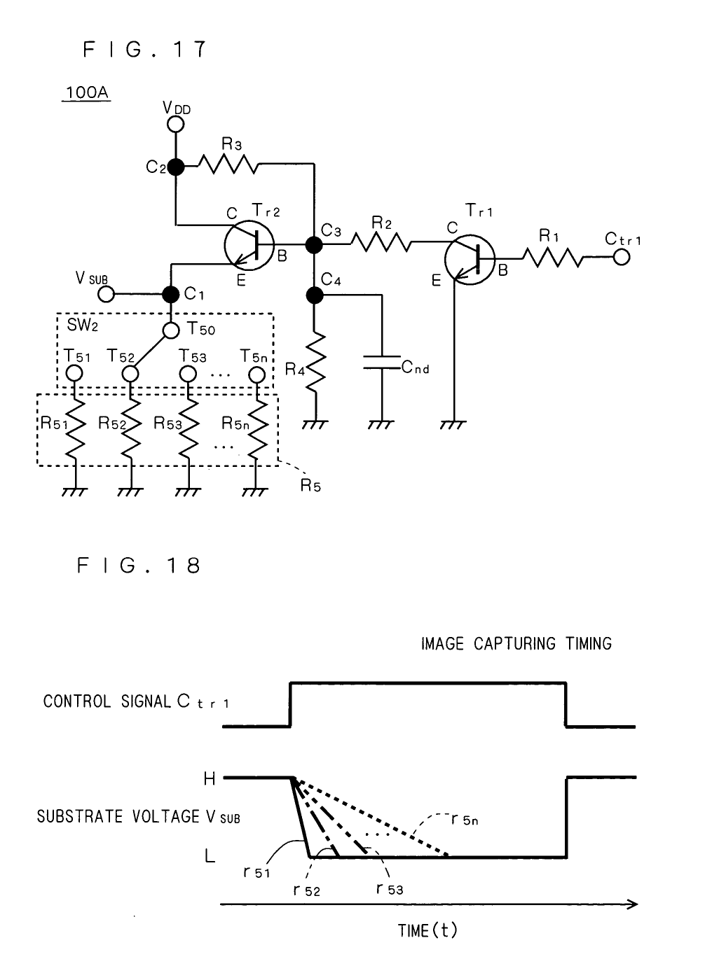

FIGS. 15 and 16 are flowcharts showing the image capturing operation flow of the image capturing apparatus 1. The operation flow is controlled by the control part 51. When the power source of the image capturing apparatus 1 is turned on in a state where the image capturing mode is set by the mode changeover switch 12 or the image capturing mode is set by the mode changeover switch 12 in a state where the power source of the image capturing apparatus 1 is ON, the image capturing operation flow starts and the program advances to step S1.

In step S1, a monitoring mode is set as the driving mode of the CCD 2, and the program advances to step S2.

In step S2, any of various image capturing modes is set, and the program advances to step S3. Herein, for example, according to an operation of depressing the sports mode button 17, the normal image capturing mode or the sports mode is set.

In step S3, at the time of image capturing, a setting state of the image capturing mode as one of image capturing conditions is detected and whether the sports mode is set or not is determined. If the sports mode is not set but the normal image capturing mode is set, the program advances to step S4. If the sports mode is set, the program advances to step S8.

First, description will be given of the case where the program advances to step S4.

In step S4, the V_{SUB} switching circuit 100 is set to be valid, and the program advances to step S5. At the time of image capturing, a setting is made to turn on the V_{SUB} switching circuit 100, that is, to decrease the substrate voltage V_{SUB}.

In step S5, whether the S1 state is set or not is determined. Herein, if the S1 state is set, the program advances to step S6. If the S1 state is not set, the determining operation in step S5 is repeated until the S1 state is set.

In step S6, AE, AF and AWB are performed, and the program advances to step S7. Since the normal image capturing mode is set, the AF control in this case is so-called one-shot AF control.

In step S7, whether the S2 state is set or not is determined. If the S2 state is set, the program advances to step S12. If the S2 state is not set, the determining operation in step S7 is repeated until the S2 state is set.

Description will be given of the case where the program advances from step S3 to step S8.

In step S8, a setting of invalidating the V_{SUB} switching circuit 100 is made, and the program advances to step S9. In step S8, at the time of image capturing, it is set so that the V_{SUB} switching circuit 100 is in the OFF state, that is, the substrate voltage V_{SUB} is not decreased.

In step S9, whether the S1 state is set or not is determined. If the S1 state is set, the program advances to step S10. If the S1 state is not set, the determining operation in step S9 is repeated until the S1 state is set.

In step S10, AE, AF and AWB are performed, and the program advances to step S11.

In step S11, whether the S2 state is set or not is determined. If the S2 state is set, the program advances to step S12. If the S2 state is not set, the program returns to step S10. That is, the processes in steps S10 and S11 are repeated until the S2 state is set. Specifically, since the sports mode is set, the AF control of maintaining the focus state on the subject (so-called continuous AF control) is performed. For the AE control, shutter speed which is relatively high speed is set.

In step S12, whether a setting of validating the V_{SUB} switching circuit 100 is made or not is determined. If a setting of validating the V_{SUB} switching circuit 100 is made in step S4, the program advances to step S13. If a setting of invalidating the V_{SUB} switching circuit 100 is made in step S8, the program advances to step S15.

In step S13, the V_{SUB} switching circuit 100 is set in the ON state (valid state) and the program advances to step S14. In the case where the image capturing condition in which the normal mode is set is detected in step S3, at the time of image capturing, the substrate voltage V_{SUB} is adjusted so as to be switched from the original substrate voltage V_{SUB} to another substrate voltage V_{SUB}.

In step S14, image processing parameters for the normal image capturing mode (e.g., the γ correction parameter of the γ characteristic shown in FIG. 11) are set, and the program advances to step S21 in FIG. 16.

On the other hand, in step S15, image processing parameters for the sports mode (e.g., the γ correction parameter of the γ characteristic shown in FIG. 13) are set, and the program advances to step S21 in FIG. 16. In this case, the setting is made to invalid the V_{SUB} switching circuit 100, so that the V_{SUB} switching circuit 100 is not set in the ON state (valid state). That is, when the image capturing condition of setting of the sports mode is detected in step S3, at the time of image capturing, the substrate voltage V_{SUB} is adjusted so as to maintain the original substrate voltage V_{SUB}.

In step S21, exposure for forming an optical image of a subject on the light reception part 2a of the CCD 2 is started, and the program advances to step S22.

In step S22, the all pixel mode is set as the CCD drive mode, and the program advances to step S23.

In step S23, exposure of the CCD 2 is finished, an image signal (signal charge) is read from all of pixels as targets, and the program advances to step S24. Herein, an amplifying process and A/D conversion are performed in the AFE 31 on the image signal read from the CCD 2, and the obtained digital image data (captured image) is temporarily stored into the image memory 41.

In step S24, the image processes such as AWB correction and γ correction are performed by the image processing part 43 on the digital image data stored in the image memory 41, an after view is displayed on the LCD 18, and the program advances to step S25. Herein, γ correction is made according to the image processing parameters set in step S14 or S15.

In step S25, the V_{SUB} switching circuit 100 is returned to the OFF state (invalid state), and the program advances to step S26.

In step S26, in a manner similar to step S1, the drive mode of the CCD 2 is reset to the monitoring mode, and the image capturing operation flow is finished. As long as the image capturing mode is set, after completion of the process in step S26, the program returns to step S1 and, according to whether photographing is performed or not, the processes from step S1 to step S26 are repeated.

As described above, the image capturing apparatus 1 according to the first embodiment controls whether the substrate voltage V_{SUB} is switched or not at the time of image capturing on the basis of the image capturing mode setting state such as the sports mode or normal image capturing mode. Therefore, for example, a special circuit for detecting whether the subject is a moving subject or not and determining whether the substrate voltage V_{SUB} is switched or not is not necessary, so that information for determining whether the substrate voltage V_{SUB} is switched or not can be easily obtained. Since switching of the substrate voltage V_{SUB} at the time of image capturing is selectively inhibited on the basis of the setting state of the image capturing mode, information indicating whether switching of the substrate voltage V_{SUB} has to be inhibited or not can be easily obtained.

Since the image capturing mode is set according to the state of the subject and the intention of the user, in the case of photographing a moving subject, occurrence of a release time lag is suppressed. In the case of photographing a stationary subject, narrowing of the dynamic range is suppressed. That is, while properly reflecting the state of the subject and the intention of the user, whether the substrate voltage V_{SUB} is switched at the time of image capturing or not is controlled. In accordance with the image capturing conditions, switching of the substrate voltage V_{SUB} at the time of photographing is selectively inhibited.

As a result, under the image capturing condition requiring high response to the image capturing operation (herein, the state where the sports mode is set), the operability is improved without switching the substrate voltage V_{SUB}. Under the image capturing condition requiring high picture quality (herein, the state where the normal image capturing mode is set), by switching the substrate voltage V_{SUB}, high picture quality can be achieved. Consequently, both improvement in operability and higher picture quality can be realized.

On the basis of whether the substrate voltage V_{SUB} is switched or not, the image process such as γ correction on a captured image is changed. Specifically, according to whether the substrate voltage V_{SUB} is switched or not, the image process on a captured image is changed. As a result, by compensating an insufficient dynamic range which occurs when the substrate voltage V_{SUB} is high at the time of image capturing, tone in a high luminance portion of a captured image can be sufficiently expressed, and color balance can be assured and optimized. That is, the picture quality of a captured image can be maintained.

### 2. Second Embodiment

In the image capturing apparatus 1 according to the first embodiment, by controlling whether the substrate voltage V_{SUB} is switched by the V_{SUB} switching circuit 100 or not, both improvement in operability and higher picture quality are realized. In an image capturing apparatus 1A according to a second embodiment, by enabling a resistor of a circuit connected to an emitter electrode of the transistor Tᵣ₂ used for a V_{SUB} switching circuit 100A to be switched, response time (i.e., the V_{SUB} switching response time) of the transistor Tᵣ₂ is made changeable. As a result, both improvement in operability and higher picture quality are achieved.

V_{SUB} Switching Circuit According to Second Embodiment

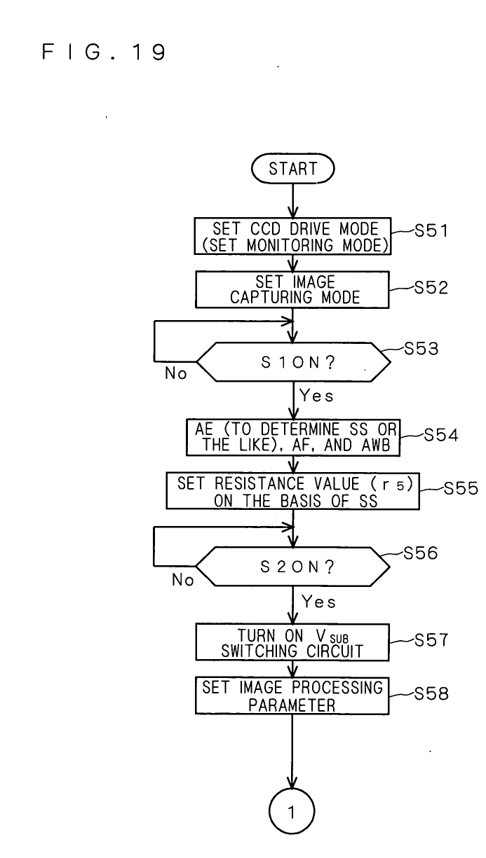

FIG. 17 is a schematic diagram showing the V_{SUB} switching circuit 100A according to the second embodiment. Since the configuration of the V_{SUB} switching circuit 100 and that of the V_{SUB} switching circuit 100A are slightly different from each other, parts similar to those of the image capturing apparatus 1 according to the first embodiment are designated by similar reference numerals and their description will not be repeated. Only different parts (part of the V_{SUB} switching circuit 100A shown in FIG. 17) will be described later.

In the V_{SUB} switching circuit 100 according to the first embodiment, the switch SW₁ for masking the Cₜᵣ₁ signal is added to the V_{SUB} switching circuit 900 shown in FIG. 9. As shown in FIG. 17, in the V_{SUB} switching circuit 100A according to the second embodiment, without adding the switch SW₁, a switch SW₂ capable of changing a resistance value of the resistor R₅ (hereinafter, referred to as “resistance change switch”) is added to the connection point C₁ of the V_{SUB} switching circuit 900 shown in FIG. 9. The other part is similar to that of the V_{SUB} switching circuit 100 or 900.

As shown in FIG. 17, the resistance change switch SW₂ is electrically connected to the connection point C₁. The resistance change switch SW₂ is provided with n+1 terminals T₅₀, T₅₁, T₅₂, T₅₃, . . . , and T₅ₙ. The terminal T₅₀ is electrically connected to the connection point C₁. n terminals T₅₁, T₅₂, T₅₃, . . . , and T₅ₙ are grounded via resistors R₅₁, R₅₂, R₅₃, . . . , and R₅ₙ, respectively.

Resistance values r₅₁, r₅₂, r₅₃, . . . , and r₅ₙ of the resistors R₅₁, R₅₂, R₅₃, . . . , and R₅ₙ have the relationship of r₅₁<r₅₂<r₅₃< . . . <r₅ₙ, and in the resistance change switch SW₂, the terminal T₅₀ and any one of the terminals T₅₁, T₅₂, T₅₃, . . . , and T₅ₙ can be electrically connected to each other. The connection state in the resistance change switch SW₂ is changed based on the control signal Cₜᵣ₂ from the control part 51. In the following, the resistors R₅₁, R₅₂, R₅₃, . . . , and R₅ₙ connected to the terminal T₅₀ will be also called the resistor R₅, and the resistance value of the resistor R₅ will be also called r₅.

FIG. 18 is a timing chart showing the relationship between the resistance value r₅ of the resistor R₅ and a change in the substrate voltage V_{SUB}. From above, states of the control signal Cₜᵣ₂ and the substrate voltage V_{SUB} are shown. With respect to the substrate voltage V_{SUB}, changes in the substrate voltage V_{SUB} are shown in the case where the resistance values of R₅ are r₅₁, r₅₂, r₅₃, . . . , and r₅ₙ.

As shown in FIG. 18, when the Cₜᵣ₁ signal is set in the ON state (state where the Cₜᵣ₁ signal is given) at the time of image capturing, in response to this, a base current of the transistor Tᵣ₁ flows and the transistor Tᵣ₁ enters the ON state, that is, a state where the emitter current flows. In this case, the base voltage of the transistor Tᵣ₂ decreases due to a change in a voltage dividing ration by the resistor R₂. As a result, the substrate voltage V_{SUB} decreases.

In this case, as shown in FIG. 18, the lower the resistance value r₅ of the resistor R₅ is, the substrate voltage V_{SUB} decreases in shorter time. Specifically, according to the connection state of the resistance change switch SW₂, time necessary for switching the substrate voltage V_{SUB} (herein, V_{SUB} switch response time) is changed. Specifically, the resistance change switch SW₂ changes the time necessary for switching the substrate voltage V_{SUB} (herein, V_{SUB} switch response time), and the control part 51 controls a change in the V_{SUB} switch response time at the time of the image capturing on the basis of image capturing conditions such as shutter speed.

In other words, the resistance change switch SW₂ can selectively switch the substrate voltage V_{SUB} and the switch response time in the operation of switching the substrate voltage V_{SUB} (herein, the V_{SUB} switch response time) is made variable. The control part 51 changes the V_{SUB} switch response time at the time of image capturing in accordance with the image capturing conditions such as shutter speed.

The lower the resistance value r₅ of the resistor R₅ becomes, the more current flowing from the transistor Tᵣ₂ to a portion around the resistor R₅ increases at the time of decreasing the substrate voltage V_{SUB}, and the amount of heat generation around the portion from the transistor Tᵣ₂ to the resistor R₅ increases. The longer the exposure time is, the more local heat noise occurs in the photoelectric converting part near the resistor R₅, so that it tends to deteriorate the picture quality.

In the image capturing apparatus 1A according to the embodiment, in order to suppress deterioration of the picture quality and a release time lag, on the basis of the shutter speed obtained by AE performed prior to the image capturing, the resistance value r₅ at the time of the image capturing is changed.

Concretely, when the shutter speed is high (when the shutter speed value is small), it is thought that the exposure time is short and the amount of heat generation near the portion from the transistor Tᵣ₂ to the resistor R₅ by switching the substrate voltage V_{SUB} is small. Consequently, the connection state of the resistance change switch SW₂ is selected so that the release time lag becomes as short as possible and the resistance value r₅ becomes a relatively small value.

On the other hand, when the shutter speed is low (when the shutter speed value is large), it is thought that the exposure time is long, a stationary subject is photographed and, further, the release time lag is short relative to the exposure time. Therefore, in such a case, the necessity of shortening the release time lag is not high. Consequently, the connection state of the resistance change switch SW₂ is selected so that the amount of heat generation near the portion from the transistor Tᵣ₂ to the resistor R₅ is suppressed as much as possible and the resistance value r₅ becomes a relatively large value.

That is, according to the exposure time (i.e., shutter speed), the resistance value r₅ of the resistor R₅ is decreased as low as possible within limits at which deterioration in picture quality does not occur. The resistance value r₅ of the limits at which deterioration in picture quality does not occur can be obtained by experiments or the like at the stage of designing of the image capturing apparatus 1A.

Image Capturing Operation Flow of Image Capturing Apparatus

FIG. 19 is a flowchart showing an image capturing operation flow of the image capturing apparatus 1A according to the second embodiment. Since steps after step S58 in FIG. 19 are similar to those of the flowchart shown in FIG. 16, their description will not be repeated. In a manner similar to the first embodiment, the operation flow is controlled by the control part 51. When the power source of the image capturing apparatus 1A is turned on in a state where the image capturing mode is set by the mode changeover switch 12 or the image capturing mode is set by the mode changeover switch 12 in a state where the power source of the image capturing apparatus 1A is ON, the image capturing operation flow starts and the program advances to step S51.

For the purpose of making description simpler, it is assumed herein that one-shot AF operation is performed irrespective of the image capturing mode.

In step S51, in a manner similar to step S1 in FIG. 15, the drive mode of the CCD 2 is set to the monitoring mode, and the program advances to step S52.

In step S52, in a manner similar to step S2 in FIG. 15, any of the various image capturing modes is set, and the program advances to step S53. Herein, for example, according to an operation of depressing the sports mode button 17, the normal image capturing mode or the sports mode is set.

In step S53, whether the S1 state is set or not is determined. When the S1 state is set, the program advances to step S54. When the S1 state is not set, the determination operation in step S53 is repeated.

In step S54, AE, AF and AWB are performed and the program advances to step S55. Herein, shutter speed (SS) or the like is determined by the AE.

In step S55, on the basis of the shutter speed (SS) set in step S54, the resistance value r₅ is set, and the program advances to step S56. The shutter speed set in step S54 is detected and the resistance value r₅ is set. Specifically, the shutter speed determined in step S54 at the time of image capturing is detected. When the first image capturing condition according to the shutter speed is detected, the substrate voltage V_{SUB} is changed from the original substrate voltage V_{SUB} to another substrate voltage V_{SUB} in first response time. On the other hand, when the second image capturing condition according to the shutter speed is detected, the substrate voltage V_{SUB} is adjusted so that the original substrate voltage V_{SUB} is switched to another substrate voltage V_{SUB} is second response time

In step S56, whether the S2 state is set or not is determined. If the S2 state is set, the program advances to step S57. If the S2 state is not set, the determination operation in step S56 is repeated until the S2 state is set.

In step S57, the V_{SUB} switching circuit 100A is set in an ON state (valid state), and the program advances to step S58. Herein, by setting the Cₜᵣ₁ signal in the ON state, that is, the state where the base current of the transistor Tᵣ₁ flows and by setting the transistor Tᵣ₁ to the ON state, that is, the state where the emitter current flows, the substrate voltage V_{SUB} is decreased.

In step S58, various image processing parameters (e.g., WB correction value and the like) are set, and the program advances to step S21 in FIG. 16.

In the case where high shutter speed is set, the resistance value r₅ is set as low as possible, the substrate voltage V_{SUB} is promptly stabilized in a low state, and the release time lag is shortened. In the case where low shutter speed is set, in order to avoid local picture quality deterioration in a captured image due to temperature rise of the CCD 2 during exposure, the resistance value r₅ is set so that the temperature of the CCD 2 is not easily increased, thereby giving priority to maintenance and assurance of the picture quality of a captured image more than shortening of the release time lag.

As described above, in the image capturing apparatus 1A according to the second embodiment, the lower the shutter speed is, the resistance value r₅ of the resistor R₅ connected to the emitter side of the transistor Tᵣ₂ of the V_{SUB} switching circuit 100A is set as low as possible. Specifically, at the time of switching the substrate voltage V_{SUB} so as to be decreased in the image capturing on the basis of the image capturing conditions such as the shutter speed, by changing the amount of current flowing from the transistor Tᵣ₂ to the resistor R₅ in the V_{SUB} switching circuit 100A, time required to switch the substrate voltage V_{SUB} of the CCD 2 at the time of image capturing (herein, V_{SUB} switch response time) is changed. Therefore, while suppressing deterioration in a captured image due to heat generation near the portion from the transistor Tᵣ₂ to the resistor R₅, a release time lag can be shortened as much as possible.

That is, by switching the resistance value r₅ of the V_{SUB} switching circuit 100A by setting the shutter speed, the release time lag and deterioration in picture quality of a captured image due to temperature rise of the CCD 2 can be balanced.

In other words, according to the image capturing condition (herein, shutter speed), the V_{SUB} switch response time of the substrate voltage V_{SUB} of the image capturing device at the time of image capturing is changed. As a result, in the image capturing condition requesting high response to the image capturing operation (herein, in the case where the shutter speed is high), the V_{SUB} switch response time is shortened, thereby improving operability. In the image capturing condition in which the degree of request of high response to the image capturing operation is relatively low (in the case where the shutter speed is low), the V_{SUB} switch response time is made long and high picture quality can be obtained. Thus, both improved operability and higher picture quality can be satisfied.

In the image capturing apparatus 1A according to the second embodiment, the V_{SUB} switch response time at the time of image capturing is changed according to the shutter speed. The present invention is not limited to the case. For example, on the basis of a set state of the image capturing mode or the like, the resistance value r₅ of the resistor R₅ can be switched in two levels or the like.

### 3. Modifications

Although the embodiments of the present invention have been described above, the present invention is not limited to the foregoing description.

For example, in the image capturing apparatus 1 according to the first embodiment, based on the sports mode setting state, the V_{SUB} switching circuit 100 is set in a valid/invalid state. The present invention is not limited thereto. For example, on the basis of the setting state of the image capturing mode such as a quick shot mode in which high shutter speed is set, the V_{SUB} switching circuit 100 may be set in a valid/invalid state.

In the image capturing apparatus 1 according to the first embodiment, based on the setting state of the image capturing mode, the V_{SUB} switching circuit 100 is set to the valid/invalid state. The present invention is not limited thereto. For example, on the basis of the states of the subject like whether the subject is a moving subject or not, the V_{SUB} switching circuit 100 may be set in the valid/invalid state.

Examples of the method of determining whether the subject is a moving subject or not include a method of detecting movement per time of the contrast or luminance pattern of a subject in a live-view image and, in the case where the continuous AF mode is set, a method of detecting a lens drive amount per time of the taking lens for continuously achieving focus on the subject.

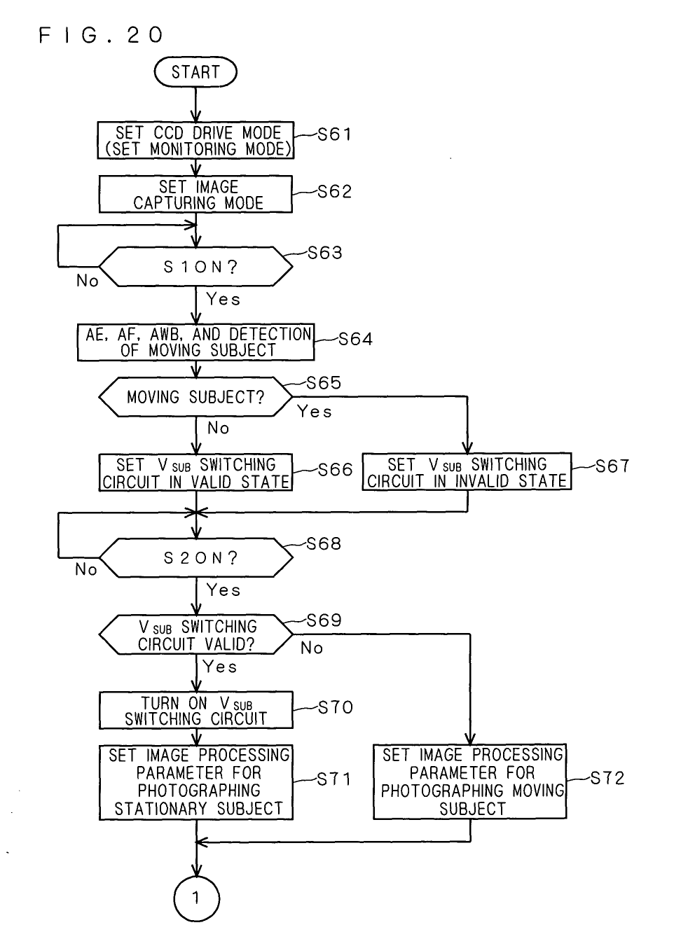

FIG. 20 is a flowchart of an image capturing operation flow of an image capturing apparatus according to a modification. Specifically, FIG. 20 shows the image capturing operation flow in the case where the V_{SUB} switching circuit 100 is set in the valid/invalid state on the basis of whether the subject is a moving subject or not. Since processes after step S72 in FIG. 20 are similar to those in the flowchart of FIG. 16, their description will not be repeated.

In a manner similar to the first embodiment, the operation flow is controlled by the control part 51. When the power source of the image capturing apparatus 1 is turned on in a state where the image capturing mode is set by the mode changeover switch 12 or the image capturing mode is set by the mode changeover switch 12 in a state where the power source of the image capturing apparatus 1 is ON, the image capturing operation flow starts and the program advances to step S61. For the purpose of making description simpler, it is assumed herein that continuous AF operation is performed irrespective of the image capturing mode.

In step S61, in a manner similar to step S1 in FIG. 15, the drive mode of the CCD 2 is set to the monitoring mode, and the program advances to step S62.

In step S62, in a manner similar to step S2 in FIG. 15, any of the various image capturing modes is set, and the program advances to step S63.

In step S63, a determination is made to see whether the S1 state is set or not. If the S1 state is set, the program advances to step S64. If the S1 state is not set, the determination operation in step S63 is repeated.

In step S64, AE, AF, AWB, and detection of a moving subject are performed and the program advances to step S65. For example, as described above, by detecting movement per time of a pattern of contrast indicative of a subject in a live view image, whether the subject is a moving subject or not can be detected.

In step S65, whether the subject is a moving subject or not is determined. On the basis of a result of the detection in step S64, if the subject is not a moving subject, the program advances to step S66. If the subject is a moving subject, the program advances to step S67.

In step S66, in a manner similar to step S4 in FIG. 15, a setting of making the V_{SUB} switching circuit 100 valid is made, and the program advances to step S68.

In step S67, in a manner similar to step S8 in FIG. 15, a setting of making the V_{SUB} switching circuit 100 invalid is made, and the program advances to step S68.

In step S68, whether the S2 state is set or not is determined. If the S2 state is set, the program advances to step S69. If the S2 state is not set, the determination operation in step S68 is repeated until the S2 state is set.

In step S68, whether a setting of making the V_{SUB} switching circuit 100 valid is made or not is checked. If the setting of making the V_{SUB} switching circuit 100 valid is made in step S66, the program advances to step S70. If the setting of making the V_{SUB} switching circuit 100 invalid is made in step S67, the program advances to step S72.

In step S70, the V_{SUB} switching circuit 100 is set in the ON state (valid state), and the program advances to step S71. Specifically, in the case where the image capturing condition that the subject is not a moving subject is detected in step S64, at the time of image capturing, adjustment of the substrate voltage V_{SUB} to switch the original substrate voltage V_{SUB} to another substrate voltage V_{SUB} is made.

In step S71, the image processing parameter for photographing a stationary subject (e.g., a parameter of γ correction of the γ characteristic shown in FIG. 11) is set, and the program advances to step S21 in FIG. 16.

On the other hand, in step S72, an image processing parameter for photographing a moving subject (e.g., a parameter of γ correction of the γ characteristic shown in FIG. 13) is set, and the program advances to step S21 in FIG. 16. Since the setting of making the V_{SUB} switching circuit 100 invalid is made herein, the V_{SUB} switching circuit 100 is not set in the ON state (valid state). In the case where the image capturing condition that the subject is a moving subject is detected in step S64, at the time of image capturing, the substrate voltage V_{SUB} is adjusted so as to maintain the original substrate voltage V_{SUB}.

In the case where the subject is a moving subject, it is thought that a priority is assigned to shortening of the release time lag more than the picture quality of a captured image, so that the V_{SUB} switching circuit 100 is set in an invalid state. On the other hand, in the case where the subject is not a moving subject, it is thought that a priority is assigned to maintenance of the picture quality of a captured image more than the release time lag, so that the V_{SUB} switching circuit 100 is set in a valid state. That is, by setting the V_{SUB} switching circuit 100 in a valid/invalid state on the basis of whether the subject is a moving subject or not, both improved operability and higher picture quality are satisfied.

Although the V_{SUB} switching circuit 100 is set in the valid/invalid state on the basis of whether the subject is a moving subject or not in the above, for example, when an image capturing mode such as a sports mode or continuous AF mode is set, the V_{SUB} switching circuit 100 may be set in an invalid state.

In the above-described first embodiment, when the sports mode is set, the V_{SUB} switching circuit 100 is set in an invalid state at the time of image capturing. The present invention is not limited thereto. When the sports mode is set, at the time of image capturing, the resistance value r₅ may be decreased.

Although the image processing parameter of γ correction on a captured image is changed on the basis of the sports mode setting state, that is, the valid/invalid setting state of the V_{SUB} switching circuit 100 in the above-described first embodiment, the present invention is not limited thereto. For example, the image processing parameter such as the intensity of an edge emphasizing process on a captured image may be changed according to the sports mode setting state. Concretely, in the case where the sports mode is set, the possibility that the subject is a moving subject is high, so that the degree of the edge emphasizing process may be increased as compared with the case where the normal image capturing mode is set.

Although the shutter speed is obtained by the AE in the above-described second embodiment, the present invention is not limited thereto. The shutter speed may be manually set by operating the operation part 52 by the user.

Obviously, by properly combining the method of setting the V_{SUB} switching circuit 100 in a valid/invalid state in the first embodiment and the method of changing the resistance value r₅ in the second embodiment, both improved operability and higher picture quality can be satisfied.

An example of the combination is that in the case where the sports mode is not set, while setting the V_{SUB} switching circuit in a valid state, the resistance value r₅ is properly changed on the basis of the shutter speed.

Although the image capturing apparatus using the CCD of the progressive type has been described as an example in the above-described embodiments, the present invention is not limited thereto but, for example, an image capturing apparatus using an interlace type CCD may be employed.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an image sensor in which a charge accumulating device is electrically interposed between a substrate and a charge transfer path;
a switching element for switching a substrate voltage in order to control a barrier voltage which is generated between said substrate and said charge accumulating device; and
a controller for controlling said switching element so as to selectively inhibit the switching of said substrate voltage at the time of image capturing in accordance with an image capturing condition.

2. The image capturing apparatus according to claim 1, wherein
said image capturing condition includes a present status of an image capturing mode of said image capturing apparatus.

3. The image capturing apparatus according to claim 2, further comprising:
a taking lens: and
a driver for driving said taking lens to a focus position of a subject, wherein
said image capturing mode includes a first mode of continuing driving of said taking lens by said driver also after a focus state is achieved on the subject, and
when said first mode is set, said controller inhibits switching of said substrate voltage.

4. The image capturing apparatus according to claim 3, wherein
said image capturing mode further includes a second mode of stopping the driving of said taking lens by said driver when the focus state is achieved on the subject, and
when said second mode is set, said controller permits switching of said substrate voltage.

5. The image capturing apparatus according to claim 1, further comprising:
a discriminator for discriminating whether the subject is a moving subject or not, wherein
when the subject is a moving subject, said controller inhibits switching of said substrate voltage.

6. The image capturing apparatus according to claim 5, wherein
when the subject is not a moving subject, said controller permits switching of said substrate voltage.

7. The image capturing apparatus according to claim 1, further comprising:
an image processor for processing image data generated by said image sensor, wherein
said image processor changes a process in accordance with a present status of said substrate voltage.

8. The image capturing apparatus according to claim 7, wherein
said image processor changes a tone conversion characteristic for said image data in accordance with the present status of said substrate voltage.

9. A method of switching a substrate voltage in an image capturing apparatus including an image sensor in which a charge accumulating device is electrically interposed between a substrate and a charge transfer path and which can control a barrier voltage which is generated between said substrate and said charge accumulating device by switching said substrate voltage, the method comprising the following steps of:
detecting an image capturing condition;
switching said substrate voltage at the time of image capturing when a first image capturing condition is detected; and
maintaining said substrate voltage at the time of image capturing when a second image capturing condition is detected.

10. An image capturing apparatus comprising:
an image sensor in which a charge accumulating device is electrically interposed between a substrate and a charge transfer path;
a switching element capable of switching a substrate voltage to control a barrier voltage which is generated between said substrate and said charge accumulating device, wherein switching time required for an operation of switching said substrate voltage is variable; and
a controller for changing said switching time for image capturing in accordance with an image capturing condition.

11. The image capturing apparatus according to claim 10, wherein
said image capturing condition includes exposure time of said image sensor.

12. The image capturing apparatus according to claim 11, wherein
said controller shortens said switching time as the exposure time of said image sensor is shortened.

13. A method of switching a substrate voltage in an image capturing apparatus including an image sensor in which a charge accumulating device is electrically interposed between a substrate and a charge transfer path and of which barrier voltage which is generated between said substrate and said charge accumulating device is controllable by switching said substrate voltage, the method comprising the steps of:
detecting an image capturing condition;
switching said substrate voltage in first response time for image capturing when a first image capturing condition is detected; and
switching said substrate voltage in second response time for image capturing when a second image capturing condition is detected.

14. The method according to claim 13, wherein
said image capturing condition includes exposure time of said image sensor.

15. The method according to claim 14, wherein
exposure time in said first image capturing condition is shorter than exposure time in said second image capturing condition, and
said first response time is shorter than said second response time.
